(19) United States
(12) Patent Application Publication
(10) Pub. No.: US 2008/0250679 A1
(43) Pub. Date: Oct. 16, 2008

(54) POINT-OF-PURCHASE MARKETING SIGNAGE METHOD AND APPARATUS

(76) Inventor: Lynne M. McNamee, Milford, CT (US)

Correspondence Address: MCGUIREWOODS, LLP, 1750 TYSONS BLVD, SUITE 1800, MCLEAN, VA, 22102, US

(21) Appl. No.: 11/871,509

(22) Filed: Oct. 12, 2007

Related U.S. Application Data
(60) Provisional application No. 60/851,043, filed on Oct. 12, 2006.

(51) Int. Cl. G09F 19/00; G09F 19/12

(52) U.S. Cl. 40/124.2; 40/124

(57) ABSTRACT

Apparatus and method for marketing products that includes a plastic, magnetic or lenticular form typically conforming in shape and size of a corresponding product being advertised and the form may have indicia applied to the form representative of information associated with the advertised product. In another aspect, an apparatus for signage is provided that includes a plastic or similar material pocket for insertion of marketing material.

This application claims benefit to U.S. Provisional application No. 60/851,043, filed Oct. 12,2006, and entitled POINT-OF-PURCHASE MARKETING SIGNAGE METHOD AND APPARATUS, the disclosure of which is incorporated by reference herein in its entirety.

### BACKGROUND OF THE INVENTION

1. Field of the Invention

The invention relates to an advertising device and method, specifically an advertising device and method for use in retail marketing displays and other types of promotional displays.

2. Related Art

The retail marketing arena is highly competitive, with an ever expanding number of products coming to market and seeking distribution to, awareness of and purchase by consumers. Within a wine and liquor retail environment, typical stores have racks where a bottle of wine rests at an angle, for example 45°, so that consumers may easily read the label on the bottle. Other bottles of wine and various spirits stand upright, again for ease of visibility and convenience of storage. However, if the most visible location for a container of that product does not contain the packaged item, for example, the top of the rack or at the front of the standing row of bottles, a consumer may not (and probably would not) know that that product was there, especially if not already familiar with that brand, vintage, or type.

Similarly, in retail arenas like grocery stores, ‘big box’ stores, hardware stores, etc., visibility is critical for completing a sale. If a consumer cannot find a product or is unaware of a product, he/she will not buy that product. Especially considering the depth of many retail shelving units, when the most forward units of a product are moved or removed, it is hard to tell if a store carries a product or where to even look to see if more units are available. This problem is exacerbated as more stores change their shelf labels to incorporate their internal coding and SKU (stock keeping unit) references, rather than spelling out what product is assigned to a particular space.

In addition, for products on lower shelves, it is especially difficult to find where a product should be, or to take notice of new products, when the front units have been moved or removed. When a person has physical limitations or is elderly with limited movement, this visibility problem becomes more significant.

Packaging serves as the primary method of Point of Purchase (POP) education and persuasion. In addition to the brand, product name and other selling information about the product appearing on package labels, incentives and promotions frequently accompany the packaging, using “hang tags” (on the bottles themselves), “stickers” (on packaging labels) , “shelf talkers” and “wobblers” (both which protrude from the shelving units). These additions to the labels and packaging provide additional space to communicate benefits of the product, discounts, co-promotions (with other brands), suggested uses, etc. If the most visible part of the product units is not viewable, consumers will not be aware of them and, thus these incentives are ineffectual.

### SUMMARY OF THE INVENTION

In light of the above, this invention intends to offer an advertising process and signage to benefit consumers, manufacturers and retail marketers. The advancement includes a marketing device that provides continued representation of the product and/or marketing incentives once the product in the most visible location is removed.

In different embodiments, the invention includes providing a process and device for promoting sales of various products in a consumer retail environment at the Point of Purchase by providing a continued or ongoing presence of a product at the Point of Purchase and to farther promote a product or incentive.

In one aspect, an apparatus for marketing products is provided that includes a die cut signage configured to represent substantially in shape and size a corresponding product being advertised by the signage and the signage adapted to receiving indicia representative of information associated with the advertised product, wherein the die cut signage has one portion of width above a central horizontal axis different in width than a portion below the central horizontal axis.

In another aspect, an apparatus for advertising is provided that includes signage having a form corresponding to a general form of an associated product to be advertised wherein the signage includes at least one pocket to receive an insert for advertising the associated product and wherein the signage includes means for affixing to a display platform.

In yet another aspect, an apparatus for advertising is provided that includes a lenticulated signage having a general form related to a product being advertised by the signage.

In another aspect, a method of advertising is provided. The method includes the steps of providing a based form substantially sized and shaped to represent an advertised product, applying indicia on the based form representing information associated with the advertised product and placing the based form proximate a location of an actual product represented by the based form and applied indicia to visually convey the advertised product to a potential customer so that the indicia continues to convey the information when the actual product is out of stock or not directly viewable by the potential customer.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIGS. 1 through 5 are illustrations of embodiments of signage according to principles of the invention;

FIG. 6 is a set of illustrations showing various exemplary shapes signage may take, according to principles of the invention;

FIG. 7 is an exemplary illustration that represents a sample of a square or rectangular sign that can be customized for signage, according to principles of the invention;

FIG. 8 is an exemplary illustration of signage where a portion of the material of signage extends beyond the edge of the shelf or shelving on which the embodiment is used;

FIG. 9 is an illustration of additional aspects of signage that represents a wine bottle of FIG. 1, according to principles of the invention;

FIG. 10A is an illustration that represents a side view with elevation when the advertising device of the invention is produced with a pocket, according to principles of the invention;

FIG. 10B is the illustration of FIG. 10A but showing the insertion of a variable insert into the pocket; and

FIG. 11 is a flow diagram of an embodiment showing steps of making and/or using the signage, according to principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices, apparatus, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

In certain aspects, the apparatus and method of the invention provides a semi-permanent marketing apparatus, such as but not limited to signage such as a counter mat-type sign, which may incorporate a plastic pouch and which contains product and/or promotional information. This would be affixed to the shelving rack or unit on which a product was sold. In this way, a continued or ongoing presence of a particular product is maintained even when the actual product or unit is removed or sold. Additional benefits may include maximizing value of space to a retailer and/or product manufacturer who can negotiate space usage, and to a consumer in regards to a continued presence as noted previously as well as advise of additional value-added offers, specials, promotions, etc.

Depending on the environment, the signage of the invention may be provided to a retail location and is professionally produceable, such as but not limited to four-color printed plastic representing a product package, or printed locally from a downloadable file from the manufacturer or distributor or generated in-house by the retailer, such as existing wine notes and ratings, which are insertable into a pouch affixed to the signage on the rack or shelf.

These descriptions herein are examples and are not meant to be considered in a limited sense. There are multiple variations having different modifications that are provided by the invention.

There are two basic categories into which this invention preferably applies, although other categories are possible (such as services): these two preferred categories include: wine/spirits and general packaged goods. For both of these categories, aspects of the invention may include custom die cut or a standard shape. Materials typically are plastic or magnetic, including lenticulars. Lenticular material typically involves lens effects. Lenticular materials are quite useful to create 3D effects. In some embodiments, the invention may involve magnetically infused plastic, a combination of magnets and/or plastic pouches or “pockets,” or strictly plastic pockets.

In one aspect, the invention may be sizeable according to the needs of the particular retail or other establishment, typically similar to the width or size of the actual product with which the signage may be used in conjunction and/or of sufficient depth (length) to prevent stocking issues. For example, if the signage according to principles of the invention is to promote a ream of paper, the size of the plastic and/or pocket typically is the same or very similar to the width of an actual ream of paper. Another example is in the situation when an embodiment of invention is meant to promote a bottle of wine, the size of the plastic signage form and/or pocket may be the same size or may be smaller (in some cases, larger) than an actual bottle, and to allow for the curvature of the racking, when applicable. Alternatively, the magnetic form (or pocket) may be sized and shaped independently of the corresponding product being advertised.

### Plastic and Magnetic Signage:

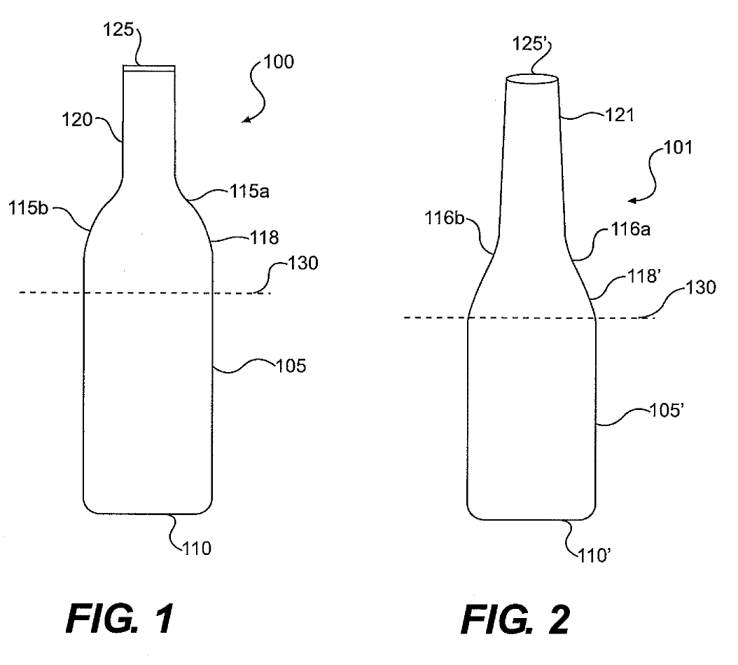

FIGS. 1 through 5 are illustrations of embodiments of signage according to principles of the invention. The signage may be made from plastic (perhaps vinyl and styrene material) and/or magnetic materials (at least in part) and may alternatively be made from ecologically friendly materials that may decompose when discarded. The signage of the embodiments herein may also employ lenticular material (such as from a lenticular lens sheet) and affects, such lenticular materials may be obtained from Motion Products Corporation, for example, Other sources of lenticular material are known, this is just one example. Lenticular materials may also be laminated to other substrates, as necessary, and may be of various colors.

Specifically, FIG. 1 illustrates exemplary signage comprising a die cut material 100 as described more herein. The die cut material may be in the shape of a “high-shouldered” bottle of wine (sometimes referred to as a “Bordeaux Bottle”), for example. The die cut material 100 may generally represent a cylindrical item such as a bottle, except in two dimensions, or alternatively two dimensions with lenticular surface aspects. Of course, any shape is possible for the die cut material and need not always conform to a particular shape of a product. The die cut material has a bottom 110 and a top 125. The die cut material 100 has a larger uniform portion 105 of generally the same width with a shoulder portion 115a, 115b that narrows to an extended narrow portion 120 (i.e., more narrow than the larger uniform portion). In this embodiment, the shoulder portion 115 is entirely above the central axis of the die cut material 100. The demarcation point 118 between the larger uniform potion and the shoulder is entirely above the horizontal axis,

In FIG. 2, the exemplary die cut material 101 includes a bottom 110′ and a top 125′ with a larger uniform portion 105′ substantially below the central horizontal axis 130. The shoulder portion 116a, 116b has a longer narrowing extent as compared with the shoulder portion 115 of FIG. 1. In this embodiment, the shoulders 116a, 116b are essentially above the central horizontal axis 130 (or, alternatively, begin the narrowing substantially proximate the horizontal axis). The demarcation point 118′may be at the horizontal axis 130. FIG. 2 represents another common wine bottle shape, typically referred to as a “Burgundy Bottle.”

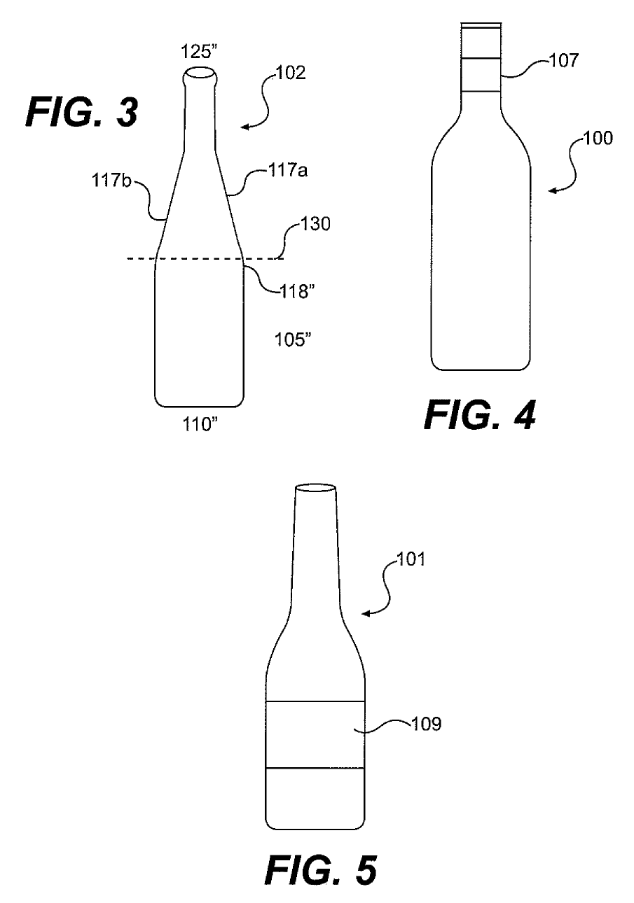

FIG. 3 is an exemplary illustration of signage, according to principles of the invention, generally denoted by 102, and representing another common wine bottle shape, referred to sometimes as a “Hoch Bottle.” In this embodiment, the demarcation point 118″ may be below the central axis. The width at the shoulders 117a, 117b is narrowing along substantially half (or more) of the total length of the signage (i.e., along substantially the demarcation point 118″ to the top 125″).

FIG. 4 is an exemplary illustration of signage and shows the embodiment of FIG. 1 configured for receiving a representation of variable copy and/or graphics. A pocket 107 would receive a graphic related to the product represented by the signage 100. Alternatively, the graphic (which might include text) may be printed directly on the signage 100 at the location designated by 107. The use of copy and/or imagery on the bottle shape may appear anywhere on the die cut bottle shape. In this example, the variable copy and/or imagery appears where a neck label traditionally appears (e.g., at location of 107) on an actual bottle of wine. This exemplary placement may be applicable to the signage of FIGS. 2 and 3, as well. The placement of the pocket or graphic may also be combined with any other placements on the die cut sign, including as represented in FIG. 5, e.g., at location of location designated as 109 (which may be the location of a pocket).

FIG. 5 is an exemplary illustration of signage that shows FIG. 2 with a pocket 109 configured to receive a representation of variable copy or graphics, according to specific applications of the invention. The use of copy and/or imagery on the bottle shape may appear anywhere on the die cut bottle shape. The graphic or copy may be applied directly onto the signage 101 without pocket 109. FIG. 5 shows as an example of the variable copy and/or imagery appearing in the place equivalent to where a printed label typically appears on an actual bottle of wine. That is, the pocket and/or placement of the graphic mimics the location where the equivalent graphic or copy would appear on the actual product (i.e., to make the signage appear as if it were the actual product itself). This possible placement may also apply to the signage of FIGS. 1 and 3, as well.

Each of these embodiments of FIGS. 1-5 preferably have typical thickness between 10 and 20 mil before adhesive (such as for styrene). Alternatively, embodiments of FIGS. 1-6 may have thicknesses of 0.005-0.020 inches (such as for plastic), and up to 0.070 inches for magnets, but may be of other thicknesses as necessary, and potentially laminated with a variety of topcoats typically applied to the non-magnetic (weak) side, most frequently laminates, vinyl materials, adhesives, or the like.

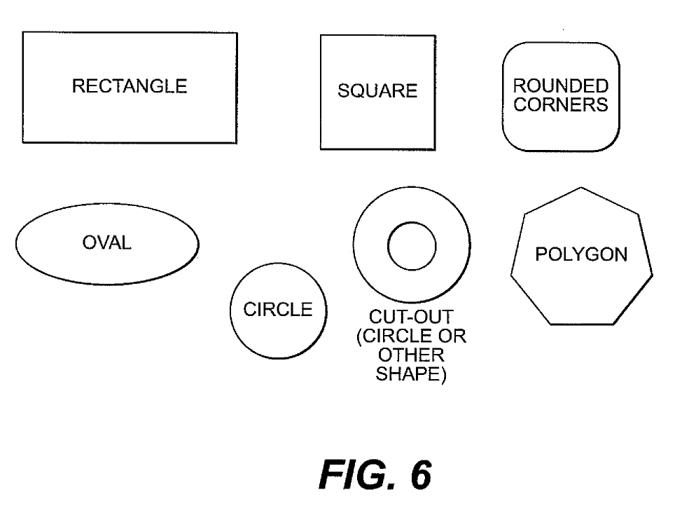

FIG. 6 is a set of illustrations showing various exemplary shapes signage may take, according to principles of the invention. As shown in the illustrations of FIG. 6, the signage may take the shape of the product being mimicked (mimicking a shape of a product is not a requirement though), and may appear as standard shapes, including but not limited to squares, rectangles, circles, ovals and stars, as well as die cut to particular shapes, including but not limited to wine bottle shapes, spirits bottle shapes, packaged good shapes, shelving space (such as I-beams for lumber at lumber and hardware suppliers). The plastic and/or magnets may be flexible to adjust to non-flat shelving units, such as wine racks. Lexan® may also be used in the embodiment of FIG. 6.

The embodiments of FIG. 1-6, may also include a combination of multiple magnets or a combination of plastic and pocket that are used together, for example, a die cut wine bottle shape with a customizable smaller label or pocket that is attached to the larger wine bottle shaped signage portion, which itself is attached, affixed or otherwise used with a wine racking system or other shelving unit. This would apply to any such combination of signage used at the shelving or point-of-purchase location, including pricing and barcode information applied alone or in conjunction with the standard or die cut versions described above.

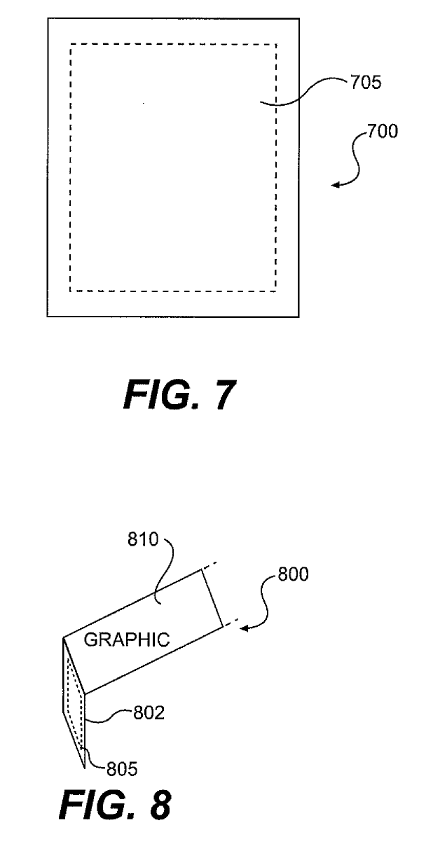

FIG. 7 is an exemplary illustration that represents a sample of a square or rectangular sign that can be customized for signage, according to principles of the invention. These would frequently be used for boxes of wine or packaged goods, such as paper, personal products, etc., that are sold on flat shelving. These would also frequently be used in stock rooms and for warehouse and retail stocking, as well as used for promotional messages. These would frequently be used for wine and spirits bottles that stand up-right on shelves, but has many additional applications, such as promotional messages (for example, “This week's special!”). The signage 700 may include a pocket 705 for receiving advertising inserts. The signage 700 may include lenticular aspects to provide visual affects (e.g., 3D affects).

FIG. 8 is an exemplary illustration of signage where a portion of the material of signage extends beyond the edge of the shelf or shelving on which the embodiment is used, generally denoted by reference numeral 800. This extension 810 typically maybe bent portion 802, have a hook and loop fasteners or any variety of methods of adhering other materials and/or other signage (not shown). The bent portion 802 may include a pocket 805 adapted to receive an insert, perhaps to deliver a message or a graphic. The signage 800 may also include lenticular aspects.

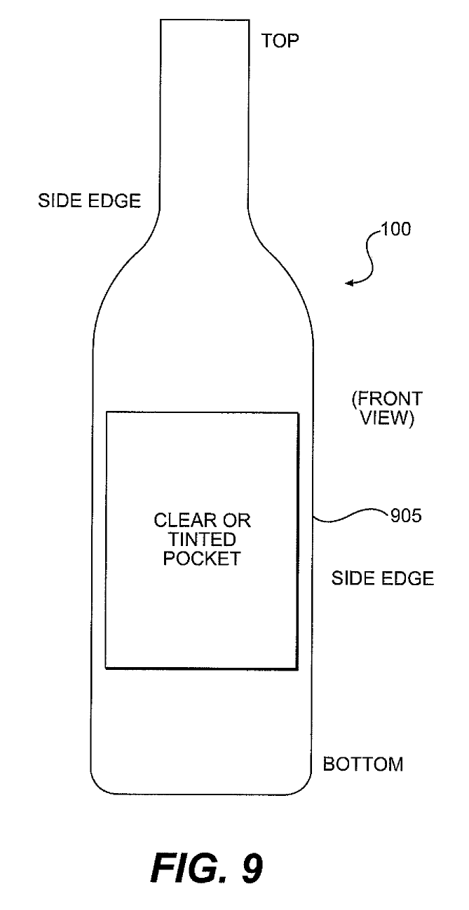

FIG. 9 is an illustration of additional aspects of signage that represents a wine bottle of FIG. 1, according to principles of the invention. Although, FIG. 9 uses a wine bottle shape as an example, the pocket aspect may apply to any other shapes and variations as discussed herein. FIG. 9 shows a clear or tinted pocket 905 that can be attached either magnetically, by a hook, or with an adhesive, according to principles of the invention. This pocket is typically sealed on three sides with one side open so an insert inserted into the pocket 905 can be changed as necessary for changing applied situations. These insertions may be magnetic, paper or other materials. The pocket on FIG. 9 is shown with the opening on the top for reference only—the location of the open side may vary, and may be on any side, or even on the back or front using a sleeve flap opening.

### Plastic Pockets:

Either independently or in combination with the above described signage, these same shapes and their respective variations may be produced entirely or portions thereof as plastic pockets. These plastic pockets allow for magnetic, paper or other materials to be inserted into the pockets for customization, variation, etc. Typically, these pockets will be made of a clear or tinted plastic and sealed on three sides (open side location may vary). Thus, FIGS. 1, 2, 3, 6, 7 and 8 illustrate certain aspects of signage provided by certain embodiments of the invention that can be made from plastic, optionally with either a full-size clear or tinted plastic pocket overtop or have a smaller clear or tinted plastic pocket affixed somewhere on the plastic signage shape. The signage may have a magnet, adhesive, clips, holes, hooks, hook and loop such as Velcro®, snaps or other suitable methods of adhering or affixing the signage to a shelving unit or display platform.

FIG. 4 and FIG. 5 may also illustrate aspects of signage of the invention made of plastic with clear or tinted plastic pockets over top a based form, Again, the placement and/or number of these pockets are exemplary. The number, quantity and placement of these pockets may vary.

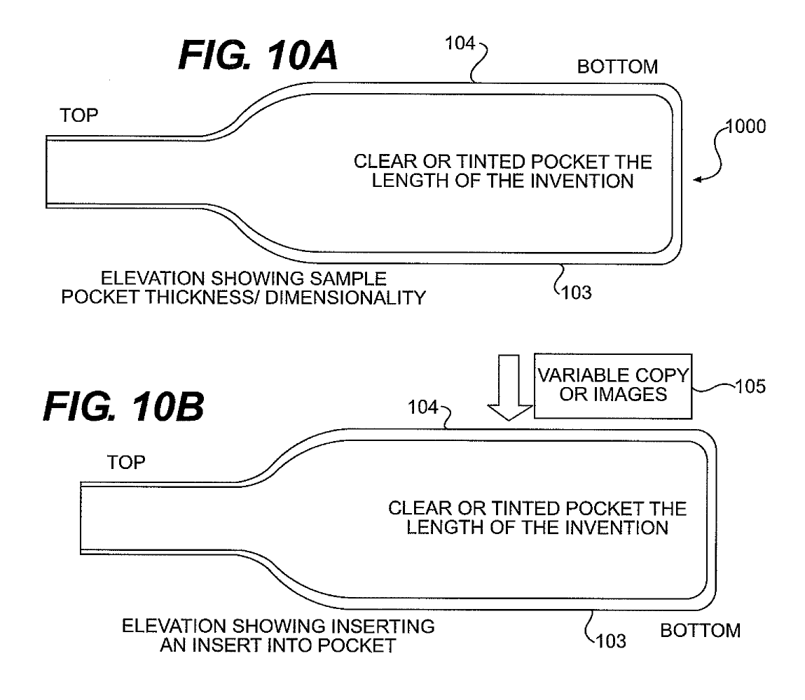

FIG. 10A is an illustration that represents a side view with elevation when the advertising device of the invention is produced as a pocket, according to principles of the invention, generally denoted as reference numeral 1000. The width of the advertising device 1000 is determined by the thickness of the backing (if magnetic, type of plastic substrate, adhesives, clips and/or other methods of affixing invention to racks and shelving units), if the entire advertising device 1000 comprises a pocket (as in FIG. 10A) or only a portion of the invention has a pocket attached. Reference numeral 103 represents the clear or tinted plastic layer that is affixed to a die cut backing, magnetic, plastic, or similar material. Reference numeral 104 indicates a sample opening for inserting and removing variable inserts, which may run a portion of the length of the advertising device 1000. FIG. 10B is the illustration of FIG. 10A but showing the insertion of a variable insert 105 into the pocket at sample opening 104.

Any of the embodiments herein may include an attaching mechanism for attaching to a rack, display platform, or a shelf including magnetically, by a hook, clasp, hole, or with an adhesive, according to principles of the invention. Moreover, the signage may continue past a shelving edge, usually with a curved edge or corners.

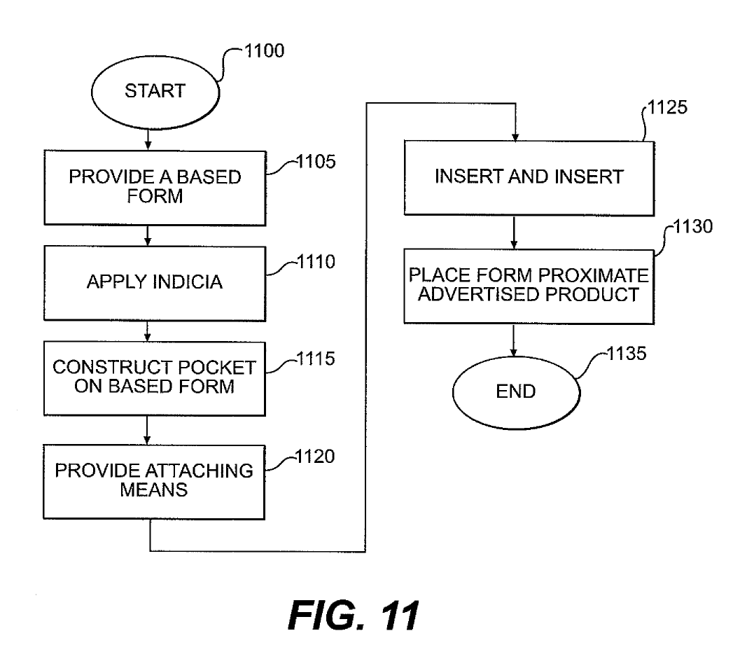

FIG. 11 is a flow diagram of an embodiment showing steps of making and/or using the signage, according to principles of the invention, starting at step 1100. At step 1105, a based form may be provided that may include a plastic form (perhaps die cut) and may be a magnetic based form. Other types of materials may be used, for example, vinyl or lenticular material. Also, in some signage, a portion (wherein the portion might be the entire based form, or less that the entire based form) of the based form may include lenticulated material. The based form may or may not be of a size of an associated product to be advertised, but is often of a similar form. At step 1110, indicia may be applied. This may include a hologram perhaps an image representing or associated in some fashion with a product to be advertised by the based form. It may be a 3D image.

At step 1115, an optional pocket(s) may be constructed on the based form for receiving an insert for advertising a product. At step 1120, an attaching means may be provided, for attaching the based form to a display platform (e.g., shelf, rack, wall, counter, beam, and the like). This attaching means might include any of a magnetic fastener (which may be inherent in the based form), a hook, adhesive, snaps, hook and loop such as Velcro®, friction fit couplers, holes for sliding over a hook, and the like. At step 1125, an insert(s) may be inserted into the pocket(s). Typically, the insert advertises the associated product. At step 1130, the based form and any inserts may be placed proximate an advertised product so that a constant display may be attained even when a product is “sold-out” or otherwise not available. At step 1135, the process ends.

### Exemplary Steps of Making and/or Using the Invention

In one embodiment, signage may be made by selecting an appropriate pattern for the signage that represents a product. In other embodiments, the signage is not related to the shape of a product, but may be any form that is suitable for delivering a message or concept, and could be sized based on the length (or depth) of a display rack, or shelf partition, for example. Optionally, a magnet or a pocket may be created for displaying a visual representation of the associated advertised item, or other advertising information.

If a magnet, cut the magnet (or magnets) to shape and add an image that represents the product or promotes the product and/or message (depending on manufacturing facilities and processes, this order may be reversed).

If a pocket, form the plastic to shape, print any images or copy, secure pocket (or pockets), and insert an image that represents the product or promotes the product and/or message. The inserts may be added at the time of production or anytime afterwards, and may be completed by the manufacturer, fulfillment shop, retailer or other appropriate party. Pockets may also be sold individually, to be added to the invention after the original invention is in use.

That which is inserted into a pocket application of the invention may be produced (printed, screened, die cut or otherwise generated) and provided by the manufacturer, distributor or other interested party, downloaded from the internet or other resource (such as a CD) as is or to be modified or originally created and produced and/or printed by the retailer/end user, or by any other party. Cutting and trimming may be required prior to physically inserting the imagery into the pocket(s). An example would be a “shelf talker” for wine, produced by the vineyard, describing the characteristics of a wine, possible ratings and/or awards, which would be downloaded from the vineyard's website, printed at a wine retail location, trimmed and inserted into the pocket.

If a combination of magnets and/or pockets is used, complete the steps above and S adhere the related magnets/pockets to form a completed POP display (or stockroom, warehouse, etc., reference identification on shelving) for the product. In some embodiments, the signage may be or include a cling, which includes statically adhering to a surface.

Affix the magnet or pocket with imagery representing the product or promoting the product and/or message on a display area. This may include hanging a magnet or pocket on the top row of a wine rack, adhering a magnet or pocket to the front flat edge of a shelving unit, whether in a retail or backroom/warehouse environment, securing a magnet or pocket on the flat portion of an I- or W-beam, or other display or storage unit. Fastening may be magnetic, with clips either affixed to the invention or to the shelving unit, an adhesion material (such as a double coated tape or semi-permanent glue) or other method as required by the location where the invention is used.

As needed or desired, the invention may be changed or moved, by removing the sign or pocket from its display location and attaching to another display location. When combinations of signs and pockets are used, the smaller signs may be removed and, if appropriate, replaced with other signs. For example, “This week's special!” may be moved on a weekly basis to different applications of the invention, whereas the original sign or pocket invention remains in place,

Various modifications and variations of the described methods and systems of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in advertising or related fields are intended to be within the scope of the following claims. Such modifications may include but are not limited to the inclusion with the various embodiments of the signage of the invention: RFID (Radio Frequency IDentification) tags, LEDs (Light Emitting Diodes), audio chips, video, and the like.

What is claimed is:

1. An apparatus for marketing products, comprising:
a die cut signage configured to represent substantially in shape and size a product being advertised by the die cut signage and the die cut signage adapted to receive indicia representative of information associated with the advertised product,
wherein the die cut signage has one portion of width above a central horizontal axis different in width than a portion below the central horizontal axis.

2. The apparatus of claim 1, wherein the die cut signage comprises at least in part magnetic material.

3. The apparatus of claim 1, wherein the die cut signage includes a pocket adapted to receive an insert for advertising.

4. The apparatus of claim 3, wherein the pocket is plastic.

5. The apparatus of claim 4, wherein the plastic is tinted.

6. The apparatus of claim 1, wherein the indicia comprises an insert for advertising the corresponding product.

7. The apparatus of claim 1, wherein the die cut signage has a central horizontal axis and includes a first portion wider than a second portion, the second portion having a width that narrows along a length of the second portion, the transition from the first portion to the second portion being a demarcation point.

8. The apparatus of claim 7, wherein the demarcation point is below the central horizontal axis.

9. The apparatus of claim 7, wherein the demarcation point is above the central horizontal axis.

10. The apparatus of claim 1, wherein the die cut signage includes a lenticular portion.

11. The apparatus of claim 1, wherein the die cut signage includes a hologram effect.

12. An apparatus for advertising, comprising a signage having a form corresponding to a general form of an associated product to be advertised wherein the signage includes at least one pocket to receive an insert for advertising the associated product and wherein the signage includes means for affixing to a display platform.

13. The apparatus of claim 12, wherein the signage is lenticulated.

14. The apparatus of claim 12, wherein the signage includes a hologram or 3D imagery.

15. An apparatus for advertising comprising a lenticulated signage having a general form corresponding to a product being advertised by the signage.

16. The apparatus of claim 15, wherein the lenticulated signage includes indicia advertising a product or service.

17. The apparatus of claim 15, wherein the lenticualted signage includes means for attaching the lenticulated signage to a shelf or rack.

18. A method of advertising, comprising the steps of:
providing a based form substantially sized and shaped to represent an advertised product;
applying indicia on the based form representing information associated with the advertised product; and
placing the based form proximate a location of an actual product represented by the based form and applied indicia to visually convey the advertised product to a potential customer so that the indicia continues to convey the information when the actual product is out of stock or not directly viewable by the potential customer.

19. The method of claim 18, wherein the based form comprises magnetic material, at least in part.

20. The method of claim 18, further comprising constructing at least one pocket on the based form to receive an insert for advertising.

21. The method of claim 18, wherein the step of providing a based form includes providing a lenticulated based form.

22. The method of claim 18, further comprising providing a means for attaching the based form to a rack or a display platform.

23. The method of claim 18, wherein the based form is substantially plastic.

24. The method of claim 18, wherein the step for applying indicia includes applying a hologram or a 3D image.
